(19) United States
(12) Patent Application Publication
(10) Pub. No.: US 2015/0090530 A1
(43) Pub. Date: Apr. 2, 2015

(54) Curved Ladder for Tank Access

(71) Applicant: Steven Richard Ambriz, Missouri City, TX (US)

(72) Inventor: Steven Richard Ambriz, Missouri City, TX (US)

(21) Appl. No.: 14/044,159

(22) Filed: Oct. 2, 2013

(51) Int. Cl. E06C 1/34; E06C 7/08; E06C 1/38

(52) U.S. Cl. CPC E06C 1/34; E06C 1/38; E06C 7/08
USPC 182/93

(57) ABSTRACT

A ladder is designed for a tank having a vertically extending side wall and a top of a convex curved profile, with an access point near the top center of the convex curved top, the ladder having a pair of parallel side rails, each side rail having a straight section at one end and a curved section at the other end, the curved section extending over the top of the tank and toward the access point, with plurality of rungs extending between and secured to the side rails, with at least one rung positioned in the straight section of the side rails and at least one rung positioned in the curved section of the side rails.

### CROSS REFERENCE TO RELATED APPLICATION

This application is a continuation of application Ser. No. 13/490,735 filed on Jun. 7, 2012 and entitled: Curved Ladder for Tank Access. Full priority based on the application is hereby claimed, and such application is incorporated by reference herein.

### BACKGROUND OF THE INVENTION

1. Field of the Invention

The subject is generally directed to a mounted ladder assembly for installation on a tank or the like to provide access to a portion of the tank not otherwise accessible and is specifically directed to a tank having curved outer walls and a curved ladder for such a tank.

2. Discussion of the Prior Art

Tanks for storing materials are well known. Such tanks generally have a port or access point at the top for filling, maintenance or other operations. The top opening or port permits access to the tank and its contents without releasing any of the materials stored therein.

Many of these tanks are of a spherical configuration, or at least include a rounded top. When ladders are required to reach the top it is necessary for the ladder to be positioned such that it clears the outer perimeter of the tank while at the same time being sufficiently close to the port to provide access. The larger the tank, the further the ladder is from the top port, often requiring either an additional platform on top of the tank or requiring the user to lean over the tank beyond the top of the ladder, creating a potential safety issue.

In addition, it is desirable that the tank and ladder footprint be kept to a minimum, particularly if the tank assembly is portable and designed to be moved about. For this reason almost all ladders are vertical or near vertical for their entire length.

A recent example of a tank safety ladder is shown and described in U.S. Pat. No. 4,848,517, entitled: “TANK SAFETY LADDER”, issued to Luda E. Broyles on Jul. 18, 1989. As there shown, the ladder is vertical and outboard from the peripheral outer wall of the tank, with a horizontal platform mounted at the top of the ladder and extending over the top portion of the tank.

The '517 patent also discusses various prior art ladders for gaining access to the top of various tanks, including a segmented ladder having various sections at different angles to accommodate the convex exterior of the tank.

### SUMMARY OF THE INVENTION

The subject invention is a ladder for providing access to a tank having a spherical or convex curved top portion and is equally suitable for any tank having a convex shape. The ladder provides easy and safe access to the top center of the tank while minimizing the footprint of the tank and ladder assembly, enhancing portability and mobility of the tank assembly.

The subject invention provides a ladder which has side support rails of a continuous curvilinear design for following the contour to the tank exterior. In the preferred embodiment the lower portion of the ladder is vertical with the upper portion curved to fit the contour of the convex top of the tank. However, it may be desirable, particularly for larger tanks, to have the lower portion at an angle for ease of use and increased safety.

In the preferred embodiment the ladder comprises to parallel side rails which are curved at the top end to generally conform to the convex top of a tank. Rungs are mounted at desired spaces and extend between the two side rails. The assembly is secured to the tank at the desired location.

The ladder of the subject invention permits the user to stay securely positioned on the ladder as he reaches the top and obtains access to a port or opening positioned in the top center of the tank. The ladder also provides comfortable support for the user when he leans over the top of the tank.

### BRIEF DESCRIPTION OF THE DRAWINGS

FIG. 1 is a side view of the ladder of the subject invention, shown as attached to a circular or cylindrical tank having a convex curved top and convex curved bottom

FIG. 2 is similar to FIG. 1, showing a user accessing a port in the center of the top of the tank using the ladder of the subject invention.

FIG. 3 is a side view of the ladder.

FIG. 4 is a perspective view of the ladder.

### DESCRIPTION OF THE PREFERRED EMBODIMENT

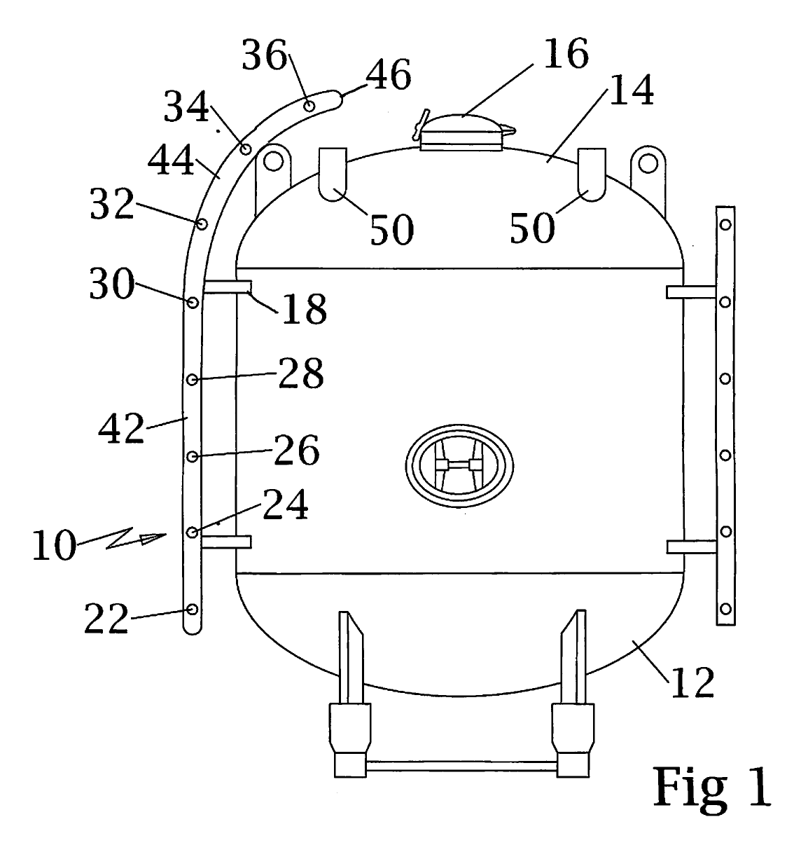

The ladder 10 of subject invention is shown in FIG. 1 as mounted on a typical tank 12 having a convex, curved top 14 with a central top port or opening 16. The ladder may be secured to the side walls of the tank 12 by a series of mounting brackets 18 which may be bolted, welded or otherwise secured to the tank 12 and the ladder 10 in the well known manner.

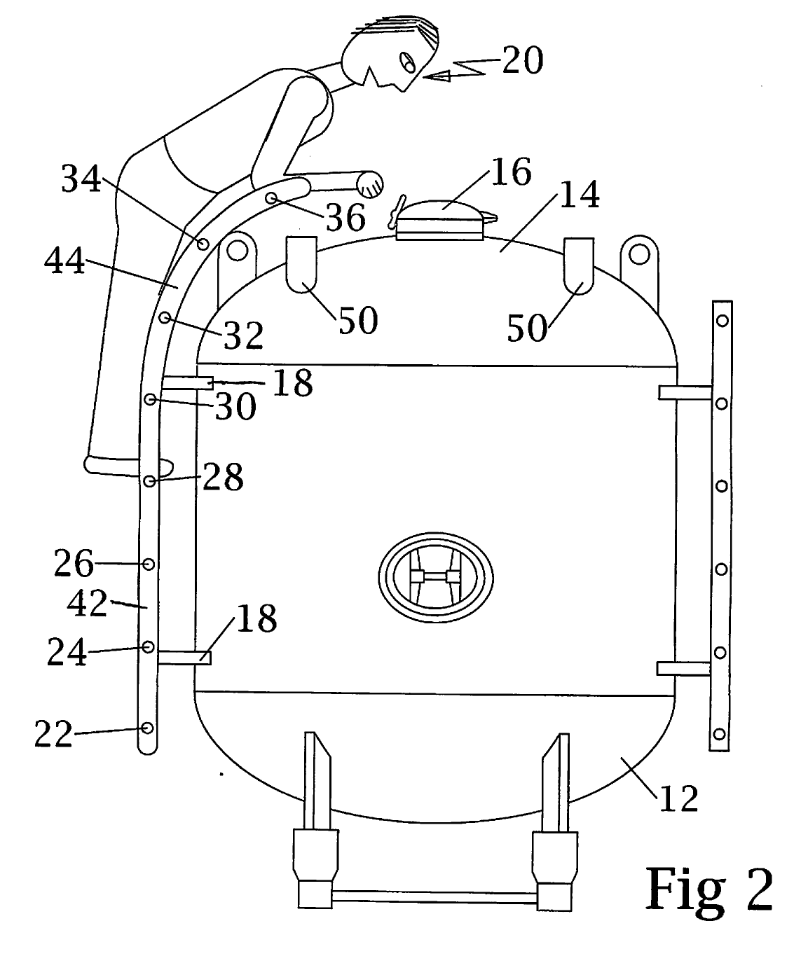

As shown in FIG. 2, when a user 20 is positioned on the ladder for gaining access to the port 16, he may lean over the top 14 of the tank while still engaging the ladder for additional comfort and support: when his foot is resting on rung 28 of the ladder, he can rest his shin on rung 30 and lean over at rung 32 while supporting his weight on rungs 34 and 36, not only increases the safety of the user, but also increases his comfort while at the same time freeing both of his hands for work without compromising support.

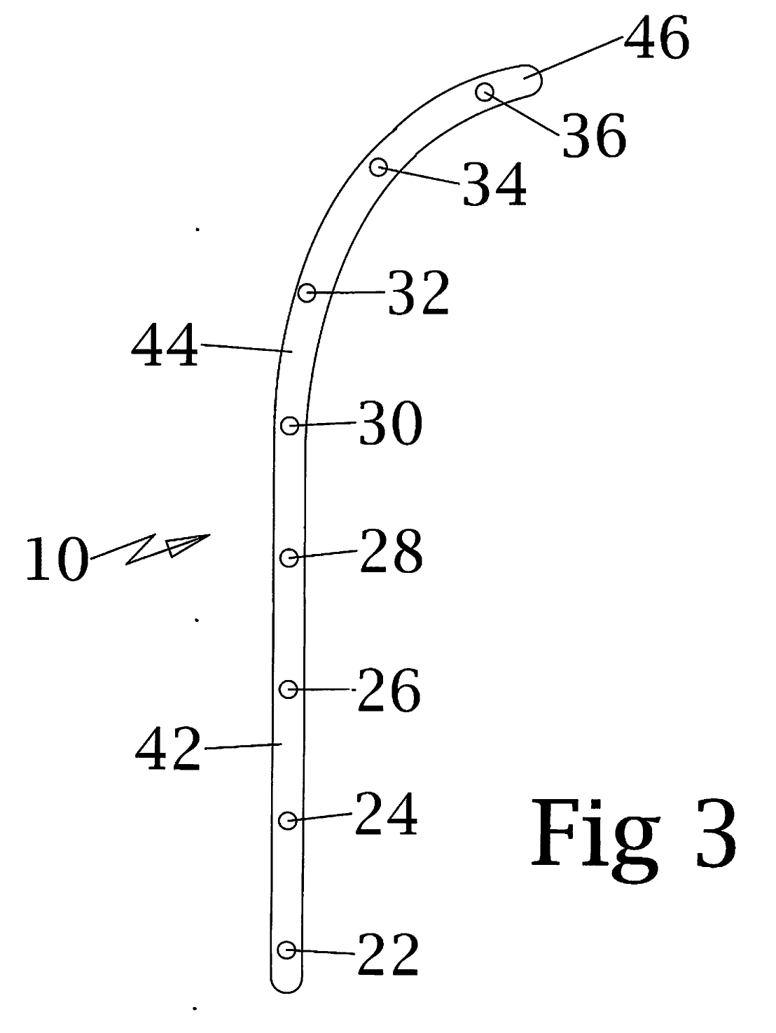

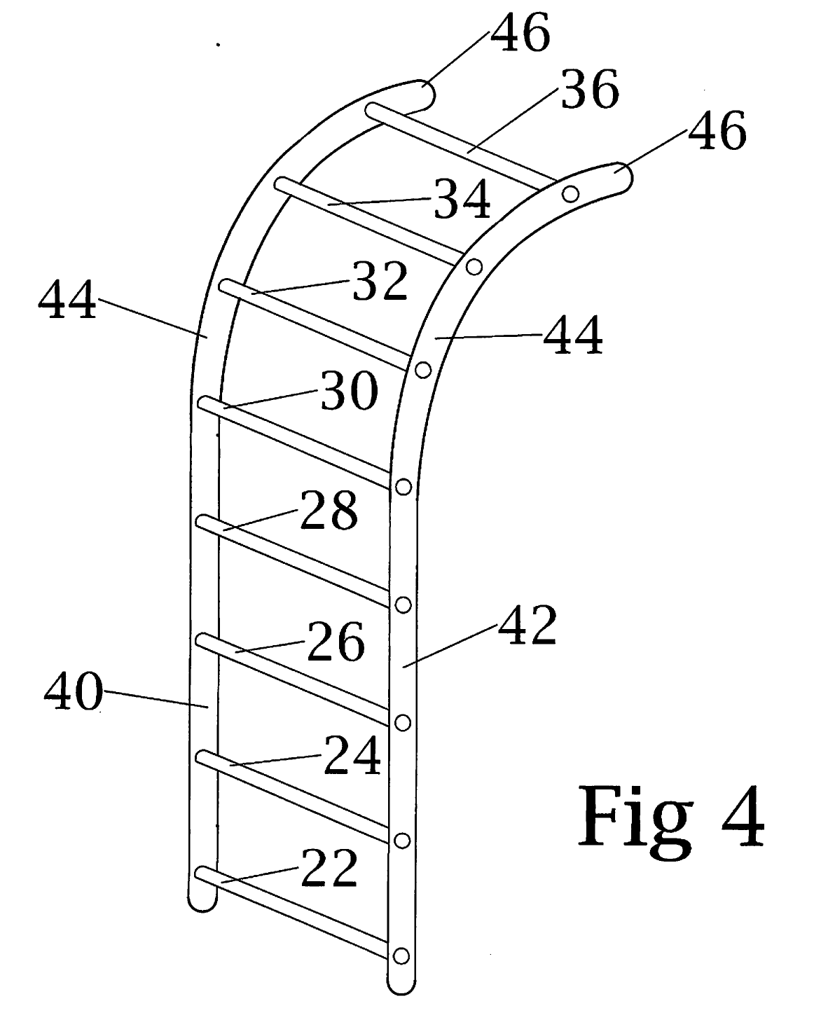

The ladder configuration is shown in FIGS. 3 and 4. As there shown, the ladder comprises a pair of parallel side rails 40 and 42. The rails are curved at the upper end 44 and terminate at a point inboard of the vertical section of the rail, as shown at 46 such that the ladder may extend over the top of the tank as shown in FIGS. 1 and 2. A plurality of ladder rungs 22, 24, 26, 28, 30, 32, 34 and 36 extend between and are secured to the side rails 40, 42 in typical manner. The rungs are spaced from one another to accommodate easy ascension and descension by the average person.

As shown in FIGS. 1 and 2, the ladder may be mounted on a tank 12 by a plurality of mounting brackets 18, in the well known manner.

In use the ladder of the subject invention enhances both the comfort and safety of the user while permitting him to use his body for support and freeing both arms and hands for work. While certain embodiments and features of the invention have been described in detail herein, it should be understood that the invention incorporates all modifications and enhancements within the scope and spirit of the following claims.

What is claimed is:

1. A ladder comprising:
a. A pair of parallel side rails, each side rail having a straight section at one end and a curved section at the other end; and
b. A plurality of rungs extending between and secured to the side rails, with at least one rung positioned in the straight section of the side rails and at least one rung positioned in the curved section of the side rails.

2. The ladder of claim 1, further including at least one mounting bracket for securing the ladder to a wall.

3. A ladder for a tank having a vertically extending side wall and a top of a convex curved profile, with an access point near the top center of the convex curved top, the ladder comprising;
a. A pair of parallel side rails, each side rail having a straight section at one end and a curved section at the other end;
b. a plurality of rungs extending between and secured to the side rails, with at least one rung positioned in the straight section of the side rails and at least one rung positioned in the curved section of the side rails; and
c. at least one mounting bracket for securing the ladder to tank side wall.

4. The ladder of claim 3, wherein the straight sections of the parallel side rails are substantially vertical.

5. The ladder of claim 3, wherein the curved sections of the parallel side rails extend along the convex curved top of the tank.

6. The ladder of claim 5, wherein the curved end of the side rails terminates at a point near the access point in the convex curved top of the tank.

7. A ladder for a tank having a vertically extending side wall and a top of a convex curved profile, with an access point near the top center of the convex curved top, the ladder comprising;
a. A pair of parallel side rails, each side rail having a straight section at one end and a curved section at the other end, with the curved section of each side rail terminating at a point near the access point near the top center of the convex curved top;
b. a plurality of rungs extending between and secured to the side rails, with at least one rung positioned in the straight section of the side rails and at least one rung positioned in the curved section of the side rails; and
c. at least one mounting bracket for securing the ladder to tank side wall.
